(19) United States
(12) Patent Application Publication
(10) Pub. No.: US 2025/0328830 A1
(43) Pub. Date: Oct. 23, 2025

(54) SYSTEMS AND METHODS FOR GENERATING INSIGHTS INTO OPERATIONAL DATA USING A LANGUAGE MODEL

(71) Applicant: PwC Product Sales LLC, New York, NY (US)

(72) Inventors: Srdjan MARINOVIC, Washington, DC (US); Laurence William PALK, Portland, OR (US); Daniel Charles RODRIGUEZ, Fairfax, VA (US); Eric STANCULESCU, Washington, DC (US)

(73) Assignee: PwC Product Sales LLC, New York, NY (US)

(21) Appl. No.: 18/640,830

(22) Filed: Apr. 19, 2024

(51) Int. Cl. G06Q 10/063

(52) U.S. Cl. CPC G06Q 10/063

(57) ABSTRACT

A method for generating insights into operational data using a language model includes receiving a user query; receiving summarized operational data, wherein summarized operational data is generated by: receiving operational data; generating an operational data graph, wherein the operational data graph comprises a plurality of nodes and edges; generating a plurality of vectors describing relationships between the plurality of nodes and edges; and applying a data model to the plurality of vectors to generate a natural language description of the plurality of vectors; generating, based on the user query and the summarized operational data, a prompt for querying a first large language model; transmitting the prompt to the first large language model; receiving a natural language response to the prompt; and generating, based on the natural language response and one or more properties of the operational data graph, one or more visualizations corresponding to the natural language response.

### FIELD

The present disclosure relates generally to systems and methods for analyzing operational data and more specifically to systems and methods for generating insights into operational data using a language model.

### BACKGROUND

Organizations generate large amounts of operational data through the use of various electronic and sensor-based systems and devices. For example, operational data may pertain to an organization's use of sensors, customer relationship management systems, enterprise resource planning systems, and/or point-of-sale systems. Given the immense volume of operational data generated as a result of using these devices and systems, extracting reliable insights (e.g., patterns, anomalies, etc.) from the data can be challenging. Conventionally, extracting insights from operational data requires a human analyst to parse through the data manually in order to summarize it. However, analyzing operational data manually is time-consuming and introduces the potential for human error.

Large language models are promising tools for summarizing large amounts of data. However, these models are typically optimized to analyze inputs such as text and image data, and are not optimized for use with structured or semi-structured data sets, such as operational data sets.

### SUMMARY

As described above, extracting useful insights from operational data can be challenging. Accordingly, there is a need for improved systems, methods, and techniques for operational data analysis.

Described herein are systems, methods, electronic devices, non-transitory storage media, and apparatuses for generating insights into operational data using a language model, which may address the above-identified need. The systems and methods described herein may transform semi-structured data streams (e.g., operational data) into textual descriptions that can be provided to a large language model. The large language model can then extract insights from the textual descriptions of the data and summarize the insights in response to a user query regarding the data. Using a large language model to summarize insights contained in operational data may eliminate the need for a human to parse the operational data, which can promote efficiency, accuracy, and cost savings.

A method for generating insights into operational data using a language model comprises: receiving a user query; receiving summarized operational data, wherein the summarized operational data is generated by: receiving operational data; generating an operational data graph, wherein the operational data graph comprises a plurality of nodes and a plurality of edges; generating a plurality of vectors describing relationships between the plurality of nodes and the plurality of edges; and applying a data model to the plurality of vectors to generate a natural language description of the plurality of vectors; generating, based on the user query and the summarized operational data, a prompt for querying a first large language model; transmitting the prompt to the first large language model; receiving a natural language response to the prompt from the first large language model; and generating, based on the natural language response and one or more properties of the operational data graph, one or more visualizations corresponding to the natural language response. In some embodiments, the user query is a natural language query. In some embodiments, the operational data comprises numerical data about operation of a device or system. In some embodiments, the operational data comprises data from a sensor, a customer relationship management system, an enterprise resource planning system, or a point-of-sale system. In some embodiments, the data model comprises one or more heuristics. In some embodiments, the data model comprises a second large language model. In some embodiments, generating, based on the user query and the summarized operational data, a prompt for querying a large language model comprises: selecting a subset of the summarized operational data that semantically matches one or more words or phrases in the user query; and generating a prompt comprising the subset of the summarized operational data and the user query. In some embodiments, generating, based on the natural language response and one or more properties of the operational data graph, one or more visualizations corresponding to the natural language response comprises: selecting one or more visualizations from a pre-determined set of visualizations. In some embodiments, the one or more properties of the operational data graph comprise an amount of data in the operational data graph. In some embodiments, the one or more visualizations corresponding to the natural language response comprise histograms, line graphs, or bar charts. In some embodiments, the method further comprises providing the natural language response to a user. In some embodiments, the method further comprises providing the one or more visualizations to a user. In some embodiments, the operational data is generated by one or more systems associated with a venue comprising a plurality of sensors. In some embodiments, the venue is a stadium. In some embodiments, receiving the user query comprises receiving a first user input executed via a graphical user interface; and displaying the one or more visualizations corresponding to the natural language response comprises displaying the one or more visualizations on the graphical user interface. In some embodiments, the method includes receiving a second user input via the graphical user interface comprising an interaction with the displayed visualization; generating, based on the second user input, a second user query; generating, based on the second user query and the summarized operational data, a second prompt for querying the first large language model; transmitting the second prompt to the first large language model; receiving a second natural language response to the second prompt from the first large language model; and generating, based on the second natural language response and one or more properties of the operational data graph, an updated version of the or more visualizations corresponding to the second natural language response.

A system for generating insights into operational data using a language model comprises one or more processors and memory storing one or more programs for execution by the one or more processors, the one or more programs comprising instructions that, when executed by the one or more processors, cause the system to perform a method comprising: receiving a user query; receiving summarized operational data, wherein the summarized operational data is generated by: receiving operational data; generating an operational data graph, wherein the operational data graph comprises a plurality of nodes and a plurality of edges; generating a plurality of vectors describing relationships between the plurality of nodes and the plurality of edges; and applying a data model to the plurality of vectors to generate a natural language description of the plurality of vectors; generating, based on the user query and the summarized operational data, a prompt for querying a first large language model; transmitting the prompt to the first large language model; receiving a natural language response to the prompt from the first large language model; and generating, based on the natural language response and one or more properties of the operational data graph, one or more visualizations corresponding to the natural language response.

A non-transitory computer-readable storage medium may store instructions that, when executed by one or more processors of an electronic device, cause the device to: receive a user query; receive summarized operational data, wherein the summarized operational data is generated by: receiving operational data; generating an operational data graph, wherein the operational data graph comprises a plurality of nodes and a plurality of edges; generating a plurality of vectors describing relationships between the plurality of nodes and the plurality of edges; and applying a data model to the plurality of vectors to generate a natural language description of the plurality of vectors; generate, based on the user query and the summarized operational data, a prompt for querying a first large language model; transmit the prompt to the first large language model; receive a natural language response to the prompt from the first large language model; and generate, based on the natural language response and one or more properties of the operational data graph, one or more visualizations corresponding to the natural language response.

In some embodiments, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for generating insights into operational data using a language model, according to some embodiments.

FIG. 2 illustrates an exemplary method for generating insights into operational data using a language model, according to some embodiments.

FIG. 3 illustrates an exemplary visualization of insights into operational data, according to some embodiments.

FIG. 4 illustrates an exemplary method for generating summarized operational data, according to some embodiments.

FIG. 5 illustrates an exemplary computing system, according to some embodiments.

### DETAILED DESCRIPTION

As described, it can be difficult to extract insights from large amounts of operational data. Large language models are promising tools for summarizing data but typically act on unstructured data, such as text or images, rather than structured or semi-structured data, such as operational data.

Accordingly, provided herein are systems and methods for generating insights into operational data using a language model.

The described systems and methods involve receiving a user query and summarized operational data. The summarized operational data may be generated by receiving operational data, creating an operational data graph comprising a plurality of nodes and a plurality of edges, generating a plurality of vectors describing relationships between the plurality of nodes and the plurality of edges, and applying a data model to the plurality of vectors to generate a natural language description of the plurality of vectors.

The system may then receive a user query, and may generate a prompt for querying a large language model, wherein the prompt is generated based on the user query and the summarized operational data. The prompt may be transmitted to the large language model, which may generate a natural language response to the prompt.

The system may then generate one or more visualizations corresponding to the natural language response, where the visualizations may be generated based on the natural language response and/or based on one or more properties of the operational data graph.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMS, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

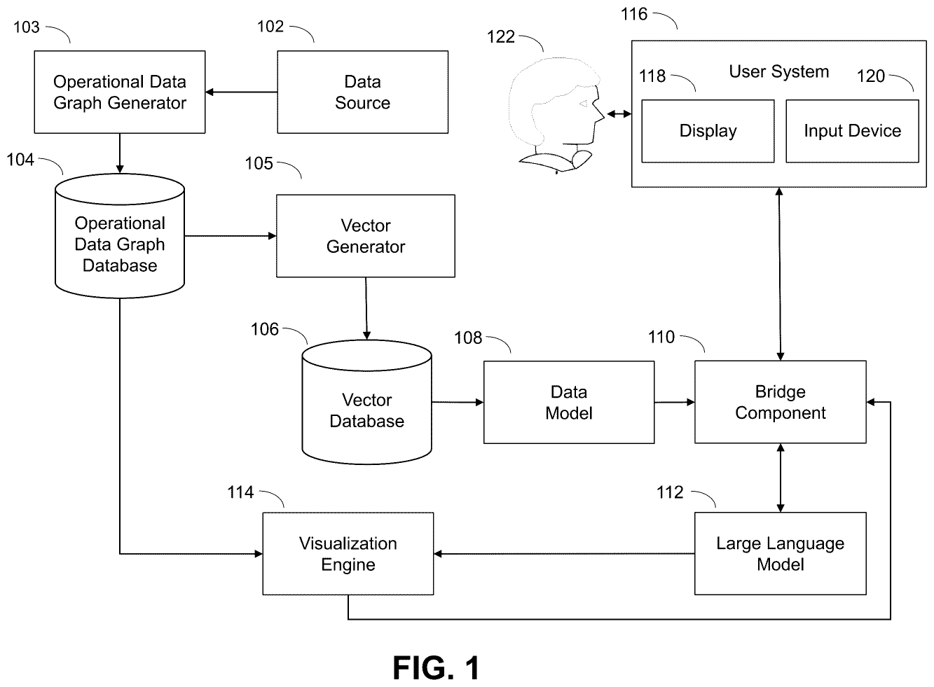

FIG. 1 illustrates an exemplary system 100 for generating insights into operational data using a language model, according to some embodiments. System 100 may include at least one data source 102. Data source 102 can be a device or system whose operation produces numerical data. For example, data source 102 may be a sensor (e.g., an IoT sensor), a camera, a customer relationship management system, an enterprise resource planning system, or a point-of-sale system. The data produced by data source 102 is hereinafter referred to as operational data. Operational data is numerical data that is produced through operation of the device or system. In some embodiments, operational data may be time series data (e.g., a set of periodic temperature sensor readings over the course of a set time period). In some embodiments, operational data may include one or more statistical distributions.

The system 100 may include an operational data graph generator 103. Operational data graph generator 103 may be configured to generate operational data graphs from operational data received from data source 102. Operational data graph generator 103 may automatically receive data from data source 102 in real time (e.g., as the device or system records operational data) or periodically (e.g., at predetermined times of day). Additionally, operational data graph generator 103 may optionally be configured to request specific operational data from a device or system, for example based on instructions received from a user 122. Furthermore, operational data graph generator 103 may optionally be configured to receive operational data via a manual upload by user 122.

An operational data graph may display operational data in a graph comprising a plurality of nodes and a plurality of edges. The plurality of nodes may represent individual data points (e.g., location points, sensor readings, transactions, communication events, interactions, etc.) corresponding to operation of a device or system. A set of nodes may correspond to a particular data source. For example, a set of nodes may correspond to a cell phone. Each node in the set may represent a location of the cell phone over a given data collection period. In other examples, sets of nodes may correspond to device types, unique identifiers for devices, locations (e.g., building, floor, or room numbers), unique identifiers for users or visitors, or interaction types. The plurality of edges may represent temporal relationships between data events (e.g., between individual nodes). For example, if the nodes represent locations of a cell phone at different times, edges can connect the nodes to represent the movement of the cell phone between measurements.

The system 100 may also include an operational data graph database 104. Operational data graph database 104 may comprise servers or databases that store operational data graphs as well as storage devices such as USB drives, hard drives, or storage disks. In some embodiments, operational data graphs generated by operational data graph generator 103 may be stored in operational data graph database 104.

System 100 may further include a vector generator 105. Vector generator 105 may be configured to convert one or more operational data graphs received from operational data graph database 104 into a plurality of vectors. The plurality of vectors may be generated from the plurality of nodes and edges in the one or more operational data graphs. Each vector may represent a behavior of a device or system being measured. For example, given an operational data graph comprising a set of nodes representing cell phone location points and a corresponding set of edges representing the temporal relationship between those location points, vector generator 105 can generate a vector that describes the movement of the cell phone over the time period represented by the nodes.

System 100 may also include a vector database 106. Vector database 106 may store the plurality of vectors corresponding to one or more operational data graphs. Vector database 106 may be communicatively coupled to vector generator 105, such that vector database 106 can receive and store vectors generated by vector generator 105. Vector database 106 may comprise servers or databases that store vectors as well as storage devices such as USB drives, hard drives, or storage disks.

System 100 may further include a data model 108. Data model 108 may be applied to a plurality of vectors from vector database 106 to summarize the plurality of vectors using natural language. In some embodiments, data model 108 comprises one or more heuristics and/or rules for summarizing vectors in natural language. In some embodiments, data model 108 may be a large language model. The large language model may be specifically designed to summarize vectors in natural language or may be a commercially available model (e.g., LLaMa, FLAN-T5). The output from data model 108 is hereinafter referred to as summarized operational data. Summarized operational data can be used to generate a prompt for a large language model to answer a user query.

Summarized operational data generated by data model 108 may include a natural language description of the plurality of vectors in vector database 106 and/or a natural language description of behavioral patterns and/or behavioral anomalies represented by the plurality of vectors. In some embodiments, data model 108 may generate a natural language description of behavioral patterns and/or anomalies by aggregating various combinations of vectors and identifying patterns in the combinations.

In some embodiments, data model 108 may aggregate vectors based on causal relationships between measured entities indicated by a user. For example, a user may indicate an interest in the impact of a first type of data (e.g., location data) on a second type of data (e.g., sales data) in the natural language user query. Accordingly, vectors corresponding to the two types of data may be aggregated. In some embodiments, data model 108 may aggregate vectors based on rankings or user preferences for different types of insights. For example, a user may indicate in the natural language user query that the user is interested in receiving insights into a first type of data (e.g., location data) and not a second type of data (e.g., sales data). Accordingly, data model 108 may aggregate vectors corresponding to the first type of data for further analysis. In some embodiments, data model 108 may aggregate vectors based on time. For example, a plurality of vectors may represent the movement of a plurality of cell phones over time. A subset of the plurality of vectors may correspond to each cell phone, representing the movement of the respective phone over a plurality of time intervals. For each cell phone, the corresponding subset of the plurality of vectors may be aggregated to form an aggregated set of vectors. Location patterns and anomalies corresponding to the cell phone may then be identified within the respective aggregated set of vectors. Location patterns and anomalies may also be identified for the entire population of tracked cell phones. Identifying patterns across all cell phones may also reveal anomalous behavior by individual cell phones as compared to the rest of the population of cell phones.

Once behavioral patterns and/or anomalies have been identified in the plurality of vectors, the data model may generate natural language descriptions of the patterns and/or anomalies. The natural language descriptions may then be provided to bridge component 110.

Bridge component 110 may be configured to receive summarized operational data from data model 108 and generate a prompt for querying a large language model 112 in order to respond to a user query. The generated prompt may be generated based at least in part on the summarized operational data. Bridge component 110 may be communicatively coupled to data model 108, large language model 112, and user system 116.

Bridge component 110 may receive a user query from a user system 116. User system 116 may include a display 118 (e.g., a computer monitor or a screen) and an input device 120 (e.g., a keyboard, a mouse, or a touch sensor). Using input device 120, a user 122 can provide a user query to bridge component 110. The user query may be a natural language query pertaining to operational data. For instance, a user query may be a request, instruction, or question about patterns or other information contained in operational data.

Upon receiving a user query, bridge component 110 can generate a prompt for a large language model 112. The large language model 112 may use the prompt to generate a natural language response to the user query. The prompt generated by bridge component 110 may comprise the user query and the summarized operational data generated by data model 108. The prompt can include the summarized operational data in its entirety or a subset of the summarized operational data that corresponds to the user query. For example, a subset of the summarized operational data that semantically matches one or more words or phrases in the user query may be selected from the summarized operational data to include in the prompt. The prompt may further include instructions for the large language model to generate a natural language response to the prompt, or for the large language model to generate a response to the prompt in any other suitable format (e.g., specifications for the format of the response). In some embodiments, the prompt may also include information regarding one or more previous query-and-answer sessions conducted by one or more previous users. For example, the prompt may include the natural language user queries, corresponding prompts, and corresponding natural language responses associated with a previous session. The prompt may further include information about the roles of the one or more previous users within the organization.

Bridge component 110 may provide the prompt to large language model 112. Large language model 112 may generate a natural language response to a user query based on the prompt. Large language model 112 may be an open source or commercially available large language model (e.g., LLaMa, FLAN-T5) or may be specifically designed to answer queries using summarized operational data. Large language model 112 may be a different large language model than data model 108. In some embodiments, large language model 112 may respond to a user query based on the summarized operational data included in the prompt provided by bridge component 110. Large language model 112 may select one or more portions of the summarized operational data that are responsive to the user query (e.g., by identifying one or more portions that semantically match one or more words or phrases in the user query). In some embodiments, large language model 112 may augment or re-word the one or more portions of the summarized operational data to provide a comprehensive response to the user query.

The natural language response to the user query generated by large language model 112 may be provided to bridge component 110, which may relay the response to user 122 via display 118 of user system 116. Bridge component 110 may also provide a visualization corresponding to the natural language response to user 122. The visualization may be generated by a visualization engine 114. Visualization engine 114 may be communicatively coupled to large language model 112 and to operational data graph database 104, such that visualization engine 114 can generate one or more visualizations based on the natural language response generated by large language model 112 and one or more properties of an operational data graph stored in operational data graph database 104 (e.g., the amount of data contained in the operational data graph). In some embodiments, visualization engine 114 may select the one or more visualizations from a pre-determined set of visualizations. The pre-determined set of visualizations may include histograms, line graphs, bar charts, or pie charts. Visualization engine 114 may select the one or more visualizations based on the compatibility of the visualization with one or more properties of the operational data graph (e.g., the size of the data set represented in the graph).

Visualization engine 114 may provide the one or more visualizations to bridge component 110, which may then provide the one or more visualizations to user 122 alongside the natural language response via display 118 of user system 116.

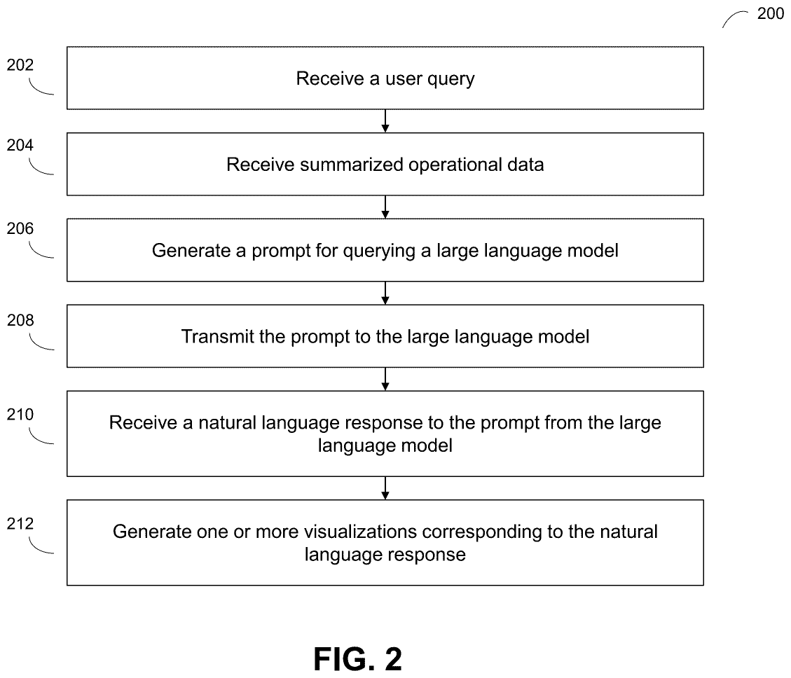

FIG. 2 illustrates an exemplary method 200 for generating insights into operational data using a language model, according to some embodiments. Method 200 is performed, for example, using one or more electronic devices implementing a software platform. In some embodiments, method 200 is performed using a client-server system, and the blocks of method 200 are divided up in any manner between the server and a client device. In other embodiments, the blocks of method 200 are divided up between the server and multiple client devices. In other embodiments, method 200 is performed using only a client device or only multiple client devices. In method 200, some blocks are, optionally, combined; the order of some blocks is, optionally, changed; and some blocks are, optionally, omitted. In some embodiments, additional steps may be performed in combination with the method 200. Accordingly, the operations illustrated (and described in greater detail below) are exemplary by nature and, as such, should not be viewed as limiting.

The method 200 may begin at step 202, wherein step 202 includes receiving a user query. The user query may be written in natural language (e.g., English text). The user query may comprise a request, instruction, or question related to operational data. For example, the user query may comprise a request to identify patterns in operational data. In some embodiments, the user query may be provided by a user via an input device of a user system, such as input device 120 of user system 116 described above with reference to FIG. 1.

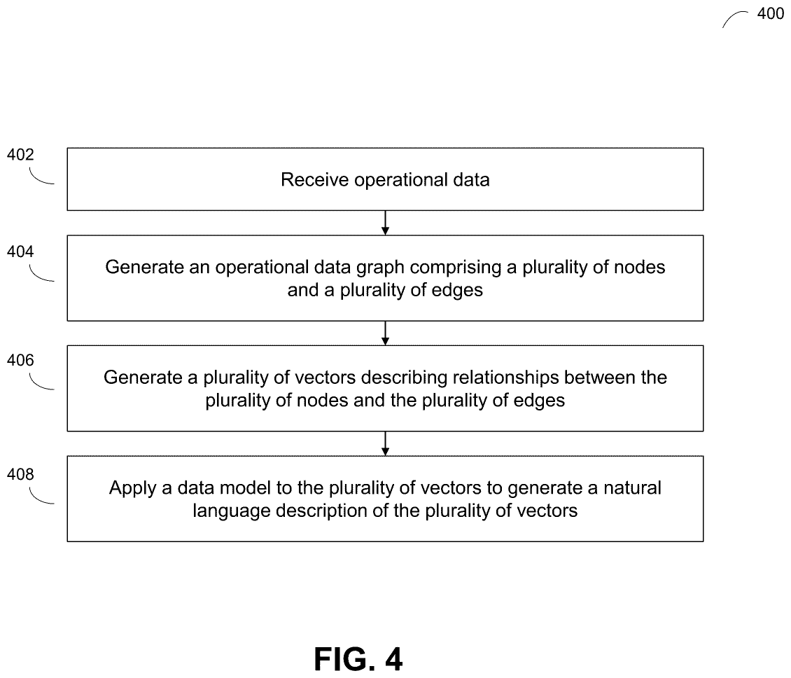

The method 200 may proceed to step 204. Step 204 comprises receiving summarized operational data. In some embodiments, the summarized operational data may comprise a natural language (e.g., English text) description of operational data. As described above with reference to FIG. 1, operational data may comprise numerical data that is produced through operation of a device or system (e.g., an IoT sensor, a camera, a customer relationship management system, an enterprise resource planning system, or a point-of-sale system). In some embodiments, operational data may comprise time series data (e.g., a set of periodic temperature sensor readings over the course of a set time period). In some embodiments, operational data can be received from a device or system such as data source 102 described above with reference to FIG. 1. The operational data may be organized as a graph, which may then be described using a plurality of vectors. The vectors can be summarized to generate summarized operational data. Summarized operational data may be generated, for example, according to method 400 described herein with reference to FIG. 4.

After receiving summarized operational data, the method 200 may proceed to step 206. Step 206 includes generating a prompt for querying a large language model. The prompt may be based on the user query received at step 202 and the summarized operational data received at step 204. The prompt may be automatically generated by a system component that is communicatively coupled to a large language model, such as bridge component 110 described above with reference to FIG. 1. In some embodiments, the prompt includes the user query and the summarized operational data. In some embodiments, the prompt includes a subset of the summarized operational data that corresponds to the user query rather than the entire corpus of summarized operational data. For example, a subset of the summarized operational data that semantically matches one or more words or phrases in the user query may be selected from the summarized operational data, and a prompt comprising the user query and the selected subset of summarized operational data may be generated. The prompt can then be used to query a large language model.

The method 200 may then proceed to step 208, wherein step 208 comprises transmitting the prompt to the large language model. The large language model may use the prompt to produce a natural language response to the prompt. In some embodiments, the large language model may be an open source or commercially available large language model, such as LLaMa or FLAN-T5. In some embodiments, the large language model may be specifically designed to respond to queries about operational data.

The method 200 may then proceed to step 210. Step 210 comprises receiving a natural language response to the prompt from the large language model. The natural language response may answer the user query based on the summarized operational data provided to the large language model in the prompt. In some embodiments, the large language model selects one or more portions of the summarized operational data (or the subset thereof provided in the prompt) that are responsive to the user query. In some embodiments, the large language model may augment or re-word the one or more portions of the summarized operational data. In some embodiments, the natural language response may be provided to a user, for example via display 118 of user system 116 described above with reference to FIG. 1.

After receiving a natural language response to the prompt from the large language model, the method 200 may proceed to step 212, wherein step 212 comprises generating one or more visualizations corresponding to the natural language response. The one or more visualizations may be generated by a visualization engine, such as visualization engine 114 described above with reference to FIG. 1. The one or more visualizations may be based on the natural language response generated by the large language model and one or more properties of the operational data graph. In some embodiments, the one or more visualizations may be selected from a pre-determined set of visualizations. The pre-determined set of visualizations may include histograms, line graphs, bar charts, or pie charts. In some embodiments, the one or more visualizations may be selected based on the natural language response and one or more properties of the operational data graph (e.g., the amount of data represented in the operational data graph). The visualization(s) selected may be the visualization(s) deemed most suitable for the amount of data contained in the operational data graph. In some embodiments, the one or more visualizations may be provided to a user, for example via display 118 of user system 116 described above with reference to FIG. 1.

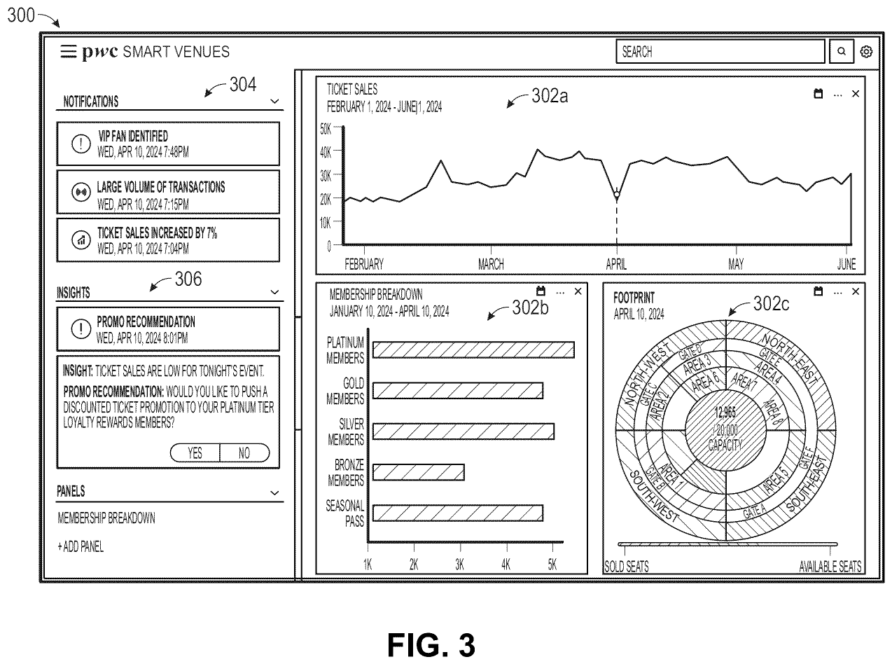

An exemplary visualization is shown in FIG. 3. In some embodiments, operational data may be derived from operation of a venue, such as a stadium. A stadium may collect operational data through a variety of systems and devices, such as IoT sensors (e.g., people-counting sensors, motion sensors, noise level sensors), cameras, customer relationship management systems, and point of sale systems, among others. A user may be interested in extracting insights from the data collected using these systems and devices. For example, the user may be interested in how many tickets are being sold to events at the stadium and who is purchasing and using them. Accordingly, the user may submit a natural language query to the system inquiring about the trends in ticket sales and attendance. Using method 200 described above with reference to FIG. 2, the system may generate a natural language response to the user query and the corresponding visualization shown in FIG. 3.

As shown, a visualization 300 may include one or more charts 302a-c illustrating data corresponding to the natural language user query. For example, chart 302a illustrates ticket sales over time, chart 302b illustrates a breakdown of the membership tiers of ticket purchasers, and chart 302c illustrates a heat map showing the seating locations of ticket purchasers.

Visualization 300 may further include natural language notifications 304 that may correspond to the data shown in charts 302a-c or to other operational data analyzed by the system. Natural language notifications 304 may include patterns and/or anomalies in the operational data. For example, natural language notifications 304 indicate that a VIP fan was identified in the stadium (e.g., by a people-counting sensor), a large volume of transactions were recorded (e.g., by a point-of-sale system), and ticket sales increased by 7% over a given period of time (e.g., as recorded by a customer relationship management system).

Visualization 300 may also include one or more natural language insights 306 into the operational data corresponding to the user query. Natural language insights 306 may include recommendations based on the patterns or anomalies identified in the operational data. For example, the natural language insight 306 shown in FIG. 3 indicates that ticket sales are low for an upcoming event at the stadium and proposes pushing a discounted ticket promotion to platinum tier loyalty rewards members to boost ticket sales.

In some embodiments, a visualization such as visualization 300 may be provided as part of a graphical user interface that allows user inputs to be automatically leveraged against the underlying system used to generate and/or modify the visualizations. For example, a user may enter a natural language prompt via a GUI, may select one or more options using GUI affordances, and/or may execute a user input to drill down on visualizations displayed in the GUI. The user inputs may cause a system such as one of the systems described herein to automatically generate and/or provide a user input that causes a visualization to be generated, updated, and/or provided in accordance with any of the methods described herein.

FIG. 4 illustrates an exemplary method for generating summarized operational data, according to some embodiments. Method 400 is performed, for example, using one or more electronic devices implementing a software platform. In some embodiments, method 400 is performed using a client-server system, and the blocks of method 400 are divided up in any manner between the server and a client device. In other embodiments, the blocks of method 400 are divided up between the server and multiple client devices. In other embodiments, method 400 is performed using only a client device or only multiple client devices. In method 400, some blocks are, optionally, combined; the order of some blocks is, optionally, changed; and some blocks are, optionally, omitted. In some embodiments, additional steps may be performed in combination with the method 400. Accordingly, the operations illustrated (and described in greater detail below) are exemplary by nature and, as such, should not be viewed as limiting.

Method 400 may begin with step 402, wherein step 402 comprises receiving operational data. As described above with reference to FIG. 1, operational data may comprise numerical data that is produced through operation of a device or system. For instance, operational data may be produced via operation of a sensor (e.g., an IoT sensor), a camera, a customer relationship management system, an enterprise resource planning system, or a point-of-sale system. In some embodiments, operational data may include time series data (e.g., a set of periodic temperature sensor readings over the course of a set time period).

After receiving operational data, method 400 may proceed to step 404. Step 404 comprises generating an operational data graph comprising a plurality of nodes and a plurality of edges. As described above with reference to FIG. 1, the plurality of nodes may represent individual data points (e.g., location points, sensor readings, transactions, communication events, interactions, etc.) corresponding to operation of a device or system. A set of nodes may correspond to a particular data source. For example, a set of nodes may correspond to a cell phone. Each node in the set may represent a location of the cell phone over a given data collection period. In other examples, sets of nodes may correspond to device types, unique identifiers for devices, locations (e.g., building, floor, or room numbers), unique identifiers for users or visitors, or interaction types. The plurality of edges may represent temporal relationships between data events (e.g., between individual nodes). For example, if the nodes represent locations of a cell phone at different times, edges can connect the nodes to represent the movement of the cell phone between measurements. The operational data graph may be generated by an operational data graph generator, such as operational data graph generator 103 described above with reference to FIG. 1, and stored in a database, such as operational data graph database 104.

Method 400 may then proceed to step 406. Step 406 includes generating a plurality of vectors describing relationships between the plurality of nodes and the plurality of edges. In some embodiments, each vector may represent a behavior of a device or system being measured. For example, for an operational data graph comprising a set of nodes representing cell phone location points and a corresponding set of edges representing the temporal relationship between those location points, a vector can be generated that describes the movement of the cell phone over the time period represented by the nodes. The plurality of vectors may be generated by vector generator 105 described above with reference to FIG. 1 and stored in a database, such as vector database 106.

Method 400 may continue with step 408, wherein step 408 comprises applying a data model to the plurality of vectors to generate a natural language description of the plurality of vectors. In some embodiments, the data model may comprise a large language model. In some embodiments, the data model may comprise or one or more heuristics and/or rules for converting vectors to text. The natural language description of the plurality of vectors generated by the data model is the summarized operational data, which may then be used to construct a prompt for a large language model to answer a user query.

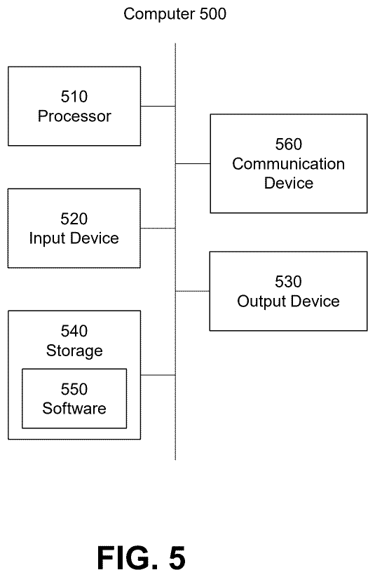

In one or more examples, the disclosed systems and methods utilize or may include a computer system. FIG. 5 illustrates an exemplary computing system according to one or more examples of the disclosure. Computer 500 can be a host computer connected to a network. Computer 500 can be a client computer or a server. As shown in FIG. 5, computer 500 can be any suitable type of microprocessor-based device, such as a personal computer, workstation, server, or handheld computing device, such as a phone or tablet. The computer can include, for example, one or more of processor 510, input device 520, output device 530, storage 540, and communication device 560. Input device 520 and output device 530 can correspond to those described above and can either be connectable or integrated with the computer.

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random-access memory (RAM), cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein.

Software 550, which can be stored in storage 540 and executed by processor 510, can include, for example, the programming that embodies the functionality of the present disclosure (e.g., as embodied in the systems, computers, servers, and/or devices as described above). In one or more examples, software 550 can include a combination of servers such as application servers and database servers.

Software 550 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A method for generating insights into operational data using a language model, the method comprising:
receiving a user query;
receiving summarized operational data, wherein the summarized operational data is generated by:
receiving operational data;
generating an operational data graph, wherein the operational data graph comprises a plurality of nodes and a plurality of edges;
generating a plurality of vectors describing relationships between the plurality of nodes and the plurality of edges; and
applying a data model to the plurality of vectors to generate a natural language description of the plurality of vectors;
generating, based on the user query and the summarized operational data, a prompt for querying a first large language model;
transmitting the prompt to the first large language model;
receiving a natural language response to the prompt from the first large language model; and
generating, based on the natural language response and one or more properties of the operational data graph, one or more visualizations corresponding to the natural language response.

2. The method of claim 1, wherein the user query is a natural language query.

3. The method of claim 1, wherein the operational data comprises numerical data about operation of a device or system.

4. The method of claim 1, wherein the operational data comprises data from a sensor, a customer relationship management system, an enterprise resource planning system, or a point-of-sale system.

5. The method of claim 1, wherein the data model comprises one or more heuristics.

6. The method of claim 1, wherein the data model comprises a second large language model.

7. The method of claim 1, wherein generating, based on the user query and the summarized operational data, a prompt for querying a large language model comprises:
selecting a subset of the summarized operational data that semantically matches one or more words or phrases in the user query; and
generating a prompt comprising the subset of the summarized operational data and the user query.

8. The method of claim 1, wherein generating, based on the natural language response and one or more properties of the operational data graph, one or more visualizations corresponding to the natural language response comprises:
selecting one or more visualizations from a pre-determined set of visualizations.

9. The method of claim 1, wherein the one or more properties of the operational data graph comprise an amount of data in the operational data graph.

10. The method of claim 1, wherein the one or more visualizations corresponding to the natural language response comprise histograms, line graphs, or bar charts.

11. The method of claim 1, further comprising:
providing the natural language response to a user.

12. The method of claim 1, further comprising:
providing the one or more visualizations to a user.

13. The method of claim 1, wherein the operational data is generated by one or more systems associated with a venue comprising a plurality of sensors.

14. The method of claim 13, wherein the venue is a stadium.

15. The method of claim 1, wherein:
receiving the user query comprises receiving a first user input executed via a graphical user interface;
displaying the one or more visualizations corresponding to the natural language response comprises displaying the one or more visualizations on the graphical user interface.

16. The method of claim 15, comprising:
receiving a second user input via the graphical user interface comprising an interaction with the displayed visualization;
generating, based on the second user input, a second user query;
generating, based on the second user query and the summarized operational data, a second prompt for querying the first large language model;
transmitting the second prompt to the first large language model;
receiving a second natural language response to the second prompt from the first large language model; and
generating, based on the second natural language response and one or more properties of the operational data graph, an updated version of the or more visualizations corresponding to the second natural language response.

17. A system for generating insights into operational data using a language model, the system comprising one or more processors and memory storing one or more programs for execution by the one or more processors, the one or more programs comprising instructions that, when executed by the one or more processors, cause the system to perform a method comprising:
receiving a user query;
receiving summarized operational data, wherein the summarized operational data is generated by:
receiving operational data;
generating an operational data graph, wherein the operational data graph comprises a plurality of nodes and a plurality of edges;
generating a plurality of vectors describing relationships between the plurality of nodes and the plurality of edges; and
applying a data model to the plurality of vectors to generate a natural language description of the plurality of vectors;
generating, based on the user query and the summarized operational data, a prompt for querying a first large language model;
transmitting the prompt to the first large language model;
receiving a natural language response to the prompt from the first large language model; and
generating, based on the natural language response and one or more properties of the operational data graph, one or more visualizations corresponding to the natural language response.

18. A non-transitory computer-readable storage medium storing instructions that, when executed by one or more processors of an electronic device, cause the device to:
receive a user query;
receive summarized operational data, wherein the summarized operational data is generated by:
receiving operational data;
generating an operational data graph, wherein the operational data graph comprises a plurality of nodes and a plurality of edges;
generating a plurality of vectors describing relationships between the plurality of nodes and the plurality of edges; and
applying a data model to the plurality of vectors to generate a natural language description of the plurality of vectors;
generate, based on the user query and the summarized operational data, a prompt for querying a first large language model;
transmit the prompt to the first large language model;
receive a natural language response to the prompt from the first large language model; and
generate, based on the natural language response and one or more properties of the operational data graph, one or more visualizations corresponding to the natural language response.
